(19) United States
(12) Patent Application Publication
(10) Pub. No.: US 2008/0079348 A1
(43) Pub. Date: Apr. 3, 2008

(54) Field Emission Type Planar Lamp And Method For The Same

(76) Inventors: Kuei-Wen Cheng, Taipei City (TW); Shie-Heng Lee, Taipei City (TW); Chun-Yen Hsiao, Taipei City (TW)

Correspondence Address: HDSL, 4331 STEVENS BATTLE LANE, FAIRFAX, VA, 22033, US

(21) Appl. No.: 11/538,132

(22) Filed: Oct. 3, 2006

(51) Int. Cl. H01J 1/02; H01J 9/24; H01J 1/16

(52) U.S. Cl. 313/495; 313/309; 313/336; 313/496; 313/497; 445/24

(57) ABSTRACT

A field emission type planar lamp with stacked structure and method for the same are proposed. The field emission type planar lamp includes an anode plate, a cathode plate and a panel. The anode plate includes a anode substrate. The cathode plate is stacked with the anode plate and includes an isolation mesh with a plurality of apertures and a cathode mesh with a plurality of through holes. The through holes are corresponding to the apertures. The panel is sealed with t he anode substrate to form a vacuum cavity to enclose the anode unit and the cathode plate. Electron beams generated by the cathode plate bombard the anode plate to illuminate. The illumination will exit from one side of the panel through passage defined by the aperture and the through, besides exit from one side of the anode substrate. Therefore, the field emission type planar lamp has two-side illumination.

### BACKGROUND OF THE INVENTION

1. Field of the Invention

The presentation relates to a lamp structure, especially to a lamp structure with field emission structure and method for the same.

2. Description of the Prior Art

As the progress of technology, people has higher demand for life quality. Especially for lighting, fluorescent lights are developed to generate line light source for providing improvement of incandescent light, which is a point light source.

However, the above-mentioned point light source and line light source still cannot provide sufficient display effect. The street lighting for advertisement or lighting for store generally require area illumination. Therefore, the point light source and the line light source use light diffusion plate to provide area illumination. However, the light is not uniform because light is emitted from the light diffusion plate and there is different light refraction angles. Moreover, electro-lamination plate can also provide area illumination. However, EL light source has insufficient brightness and the life span of the EL light is also insufficient.

Because the above-mentioned prior art light source for area illumination cannot provide sufficient illumination, new area illumination such as field emission light source is developed. In the field emission light source, cathode electron emitter emits electrons in a vacuum environment by applying a voltage difference. The emitted electrons are accelerated by anode to excite phosphor for emitting visible light, thus providing a compact area light source. The color of the area light source can be changed by changing the material of phosphor. Therefore, the field emission light source becomes one of technologies under extensive researches.

However, in early stage of field emission light source, it uses structure similar to the cathode ray tube and a very large voltage difference is used to drain the electron beam. The lamp is bulky and difficult to apply for ordinary life. Therefore, thin and compact field emission display (FED) device is developed to overcome above drawback, where planar cathode and anode are used for emitting electronic beams. The FED device can emit electron beam under low voltage operation.

There are many FEC-based lamp in prior art such as a lighting lamp of triode structure proposed by Japan Futaba Corp. However, this lighting lamp of triode structure has complicated structure and has only one light emitting side, which is still not sufficient.

### SUMMARY OF THE INVENTION

It is the object of the present invention to provide a field emission type planar lamp with two-side illumination and method for the same, where the process is simplified to reduce cost.

Accordingly, the present invention provides a field emission type planar lamp with two-side illumination and method for the same. The field emission type planar lamp includes an anode plate, a cathode plate and a panel. The anode plate includes a anode substrate. The cathode plate is stacked with the anode plate and includes an isolation mesh with a plurality of apertures and a cathode mesh with a plurality of through holes. The through holes are corresponding to the apertures. The panel is sealed with t he anode substrate to form a vacuum cavity to enclose the anode unit and the cathode plate. Electron beams generated by the cathode plate bombard the anode plate to illuminate. The illumination will exit from one side of the panel through passage defined by the aperture and the through, besides exit from one side of the anode substrate. Therefore, the field emission type planar lamp has two-side illumination.

### BRIEF DESCRIPTION OF THE DRAWINGS

FIG. 1 shows the sectional view of the anode plate of the present invention.

FIGS. 2(a) and (b) are section views of the cathode plate of the present invention.

FIGS. 3(a) and (b) are section views of the panel of the present invention.

FIGS. 4(a) and (b) show the process to assemble section views of the cathode plate of the present invention.

FIGS. 5(a) and (b) are schematic view for showing the planar lamp of the present invention.

FIG. 6 is sectional view for showing the planar lamp of the present invention.

FIG. 7 is a partially enlarged view to show the operation of the present invention.

FIGS. 8 shows the process steps S1 to S5.

### DETAILED DESCRIPTION OF THE PREFERRED EMBODIMENTS

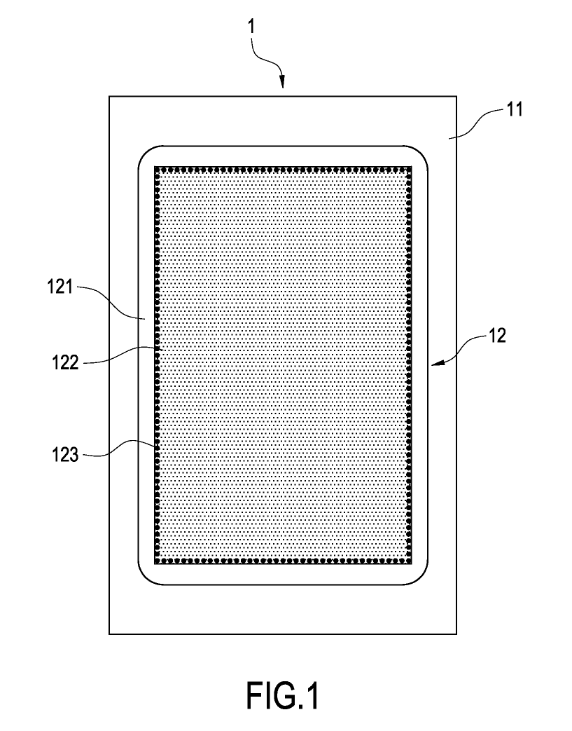

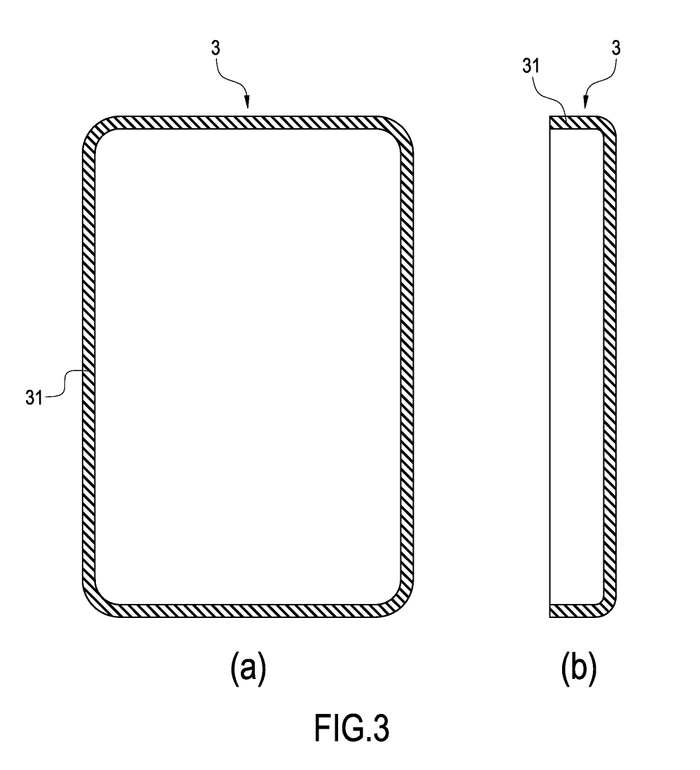

With reference to FIGS. 1 to 5, the planar lamp structure of the present invention comprises an anode plate 1, a cathode plate 2 and a panel 3, where the anode plate 1 is opposite to the cathode plate 2. The anode plate 1 comprises an anode substrate 11 made of glass material and a plurality of anode units 12 is arranged on the anode substrate 11. The anode unit 12 comprises an anode conductive layer 121 coated with a phosphor layer 122. An isolation wall 123 is provide atop the phosphor layer 122 to support the anode plate 121 and provide air passageway of vacuum environment. The anode plate 1 is fabricated by providing a glass anode substrate 11 coated with conductive layer 121 or a glass coated with indium-tin oxide (ITO) layer. Afterward, mesh-printing or lithography are used o form the phosphor layer 122 on the conductive layer 121 and then mesh-printing or implantation are used to form the isolation wall 123.

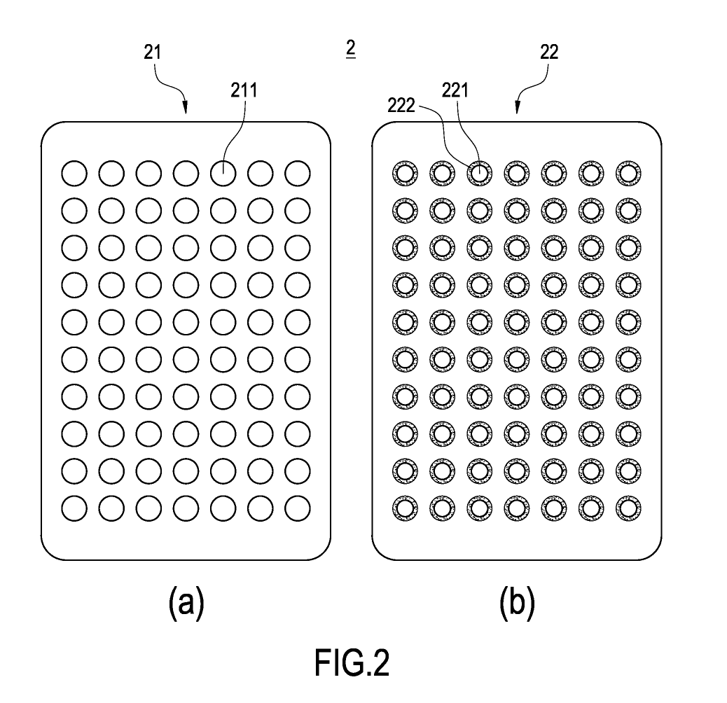

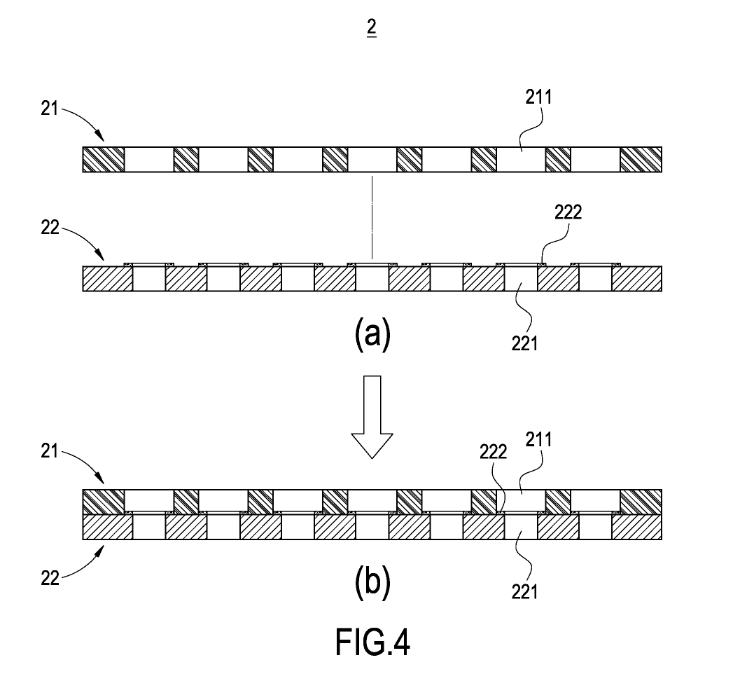

With reference to FIGS. 2A to 2B and FIGS. 4a to 4B, the cathode plate 2 comprises an insulating mesh 21 and a cathode mesh 22. The insulating mesh 21 is made of glass material and arranged between the anode plate 1 and the cathode mesh 22. The insulating mesh 21 is supported by the isolation wall 123 to provide isolation for the anode plate 1 and the cathode mesh 22. The insulating mesh 21 is provided with apertures 211 with separations therebetween. The insulating mesh 21 is formed by etching or sand-blasting on the substrate to form the apertures 211. The cathode mesh 22 is a metal mesh and comprises a plurality of through holes 221 with separations therebetween. The through holes 221 are corresponding to the apertures 211 of the insulating mesh 21. The diameter of the through hole 221 is slightly smaller than that of the aperture 211 of the insulating mesh 21. A plurality of cathode electron emitting sources 222 are arranged around the through holes 221 and the cathode electron emitting sources 222 are realized by carbon nanotubes. The cathode electron emitting sources 222 form annulus projections. Therefore the cathode electron emitting sources 222 are arranged in the apertures 211 when the cathode mesh 22 is assembled with the insulating mesh 21, as shown in FIG. 4B. Moreover, the panel 3 is made of glass material to assemble with the anode substrate 11 of the anode plate 1. A skirt wall 31 is formed from peripheral of the panel 3. Therefore, the anode unit 12 and the cathode plate 2 are enclosed when the panel 3 is assembled with the substrate 11 to form a closed vacuum chamber 20, which will be detailed later.

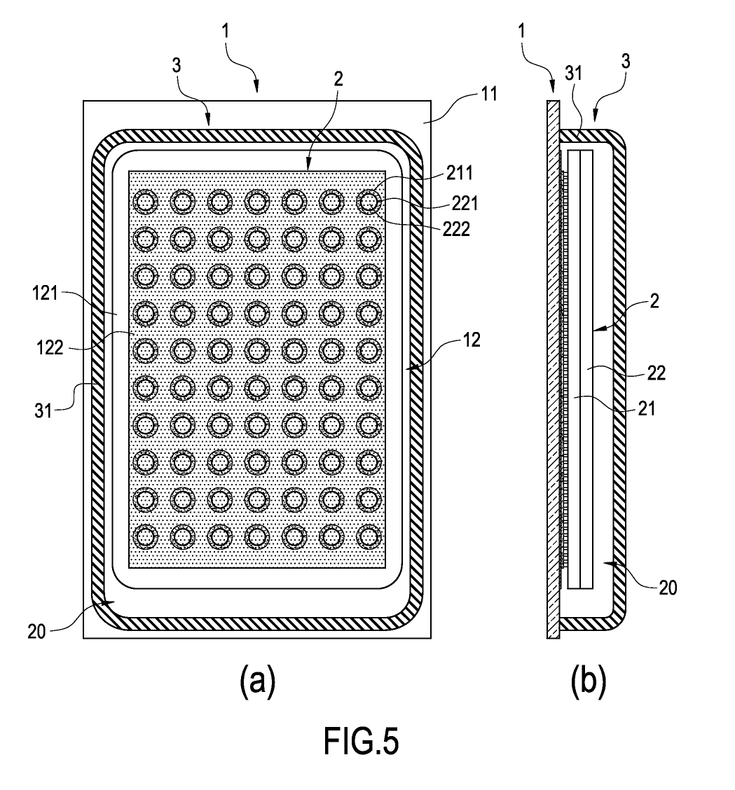

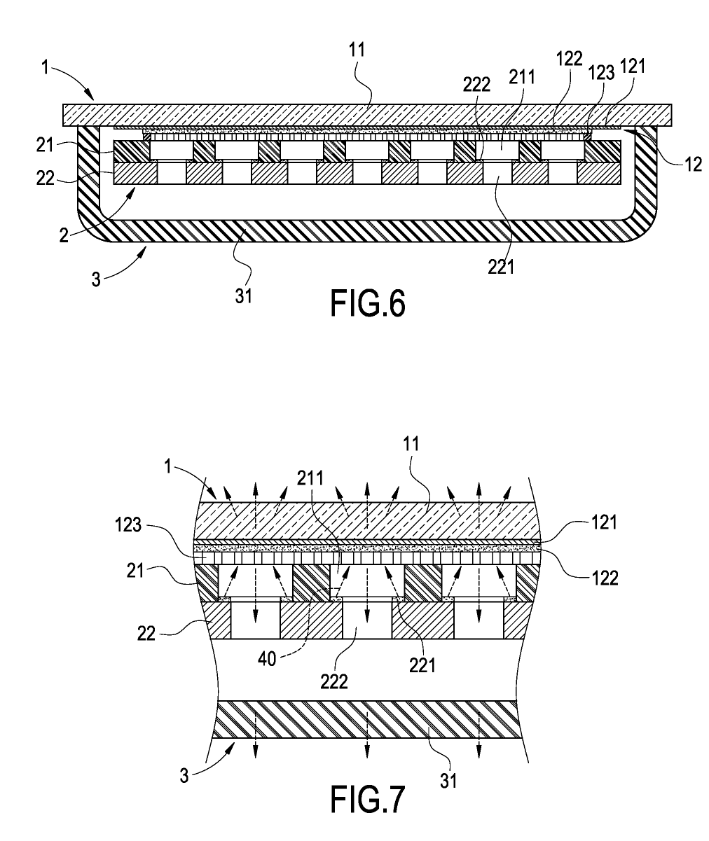

With reference to FIGS. 5 to 7, the anode plate 1 is first assembled with the cathode plate 2, and then assembled with the panel 3 to form a vacuum chamber 20. Therefore, the cathode plate 2 and the anode unit 12 are enclosed therein. Moreover, the cathode electron emitting sources 222 on the cathode mesh 22 are corresponding to and accommodated in the apertures 211 and corresponding to the phosphor layer 122. When external electrical field is led in the anode unit 12 and the cathode mesh 22, an electrical field is generated therebetween. Therefore, electron beams 40 are drained from cathode electron emitting sources 222 and pass the apertures 211 for emitting toward the phosphor layer 122. The phosphor layer 122 is excited to emit light to provide a light emitting area in the vacuum chamber 20. At this time, the light caused by bombardment of the electron beams 40 on the phosphor layer 122 emits from one side of the anode plate 11 and then emits from one side of the panel 3 after passing the apertures 211 and the through holes 221 to form a planar lamp with two-side light emission, as shown in the arrow.

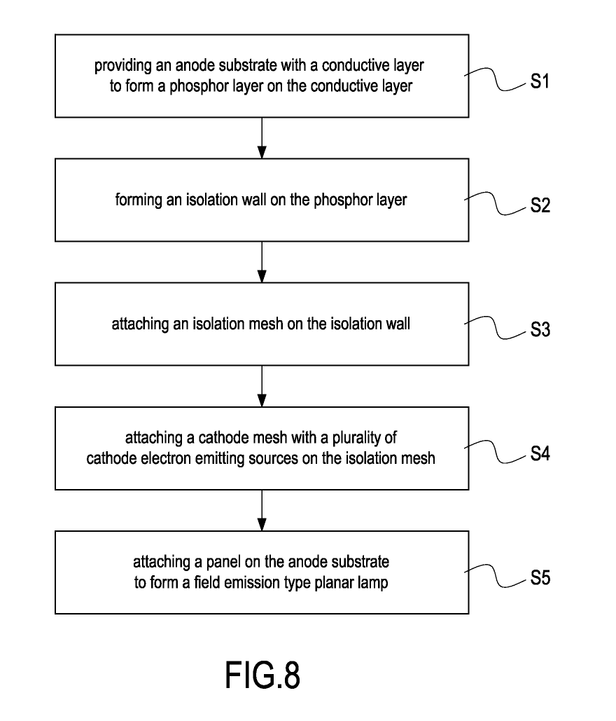

With reference to FIG. 8, the components of the present invention can be made individually and then assembled and packaged. This is exemplified with the assembling process of the anode plate 1, the cathode plate 2 and panel 3. An anode substrate 11 made of glass and having conductive layer 121 is prepared, and a phosphor layer 122 is formed on the anode substrate 11 by mesh-printing and lithography in step S1. Isolation walls 123 are formed on the phosphor layer 122 by mesh-printing or implantation in step S2. Another glass substrate is provided to form an insulating mesh 21 by etching and sand-blasting, and the insulating mesh 21 is bound to the phosphor layer 122 by glass glue in step S3. A cathode mesh 22 is attached on the isolation mesh 21 in step S4, where the cathode mesh 22 is formed by metal mesh and carbon nanotubes are formed thereon by mesh printing, lithography or electrophoresis. Finally, the panel 3 is sealed to the anode substrate 11 by vacuum package process in step S5 to form the planar lamp of the present invention.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A field emission type planar lamp, comprising:
an anode plate comprising an anode substrate and anode units thereon;
a cathode plate comprising an insulating mesh and a cathode mesh, which is assembled with the anode units;
a panel sealed with the anode substrate and comprising outward-extending skirt wall on circumference thereof to linearly enclose the anode unit and the cathode plate;
wherein a vacuum cavity is defined by the skirt wall after the anode plate 1 is sealed with the panel 3.

2. The field emission type planar lamp as in claim 1, wherein the insulating mesh comprises a plurality of apertures 211 and the cathode mesh comprises a plurality of through holes corresponding to the apertures, the through holes comprise a plurality of electron emitting sources on peripheral thereof.

3. The field emission type planar lamp as in claim 2, wherein the diameter of the through hole is smaller than that of the aperture.

4. The field emission type planar lamp as in claim 2, wherein the cathode electron emitting sources form annulus projections.

5. The field emission type planar lamp as in claim 2, wherein the cathode electron emitting sources around the through holes are fit within the aperture.

6. The field emission type planar lamp as in claim 2, wherein the cathode electron emitting sources are realized by carbon nanotube.

7. The field emission type planar lamp as in claim 1, further comprising isolation wall on the anode unit to support the cathode plate.

8. The field emission type planar lamp as in claim 1, wherein the anode substrate is made of glass material.

9. The field emission type planar lamp as in claim 1, wherein the isolation mesh is made of glass material.

10. The field emission type planar lamp as in claim 1, wherein the cathode mesh is made of metal mesh.

11. The field emission type planar lamp as in claim 1, wherein the panel is made of glass.

12. A method for manufacturing field emission type planar lamp, comprising:
(a). providing an anode substrate with a conductive layer;
(b). forming a phosphor layer on the conductive layer;
(c). forming an isolation wall on the phosphor layer;
(d). attaching an isolation mesh on the isolation wall;
(e). attaching a cathode mesh with a plurality of cathode electron emitting sources on the isolation mesh; and
(f). attaching a panel on the anode substrate.

13. The method as in claim 12, wherein the anode substrate is a conductive glass coated with indium-tin oxide (ITO).

14. The method as in claim 12, wherein in step (b), the phosphor layer is formed on the conductive layer by mesh printing or photo lithography.

15. The method as in claim 12, wherein in step (c), the isolation wall is formed on the phosphor layer by mesh printing or implantation.

16. The method as in claim 12, wherein the isolation mesh is made of glass.

17. The method as in claim 12, wherein in step (d), the isolation mesh is formed by etching or sand blasting.

18. The method as in claim 12, wherein the cathode mesh is made of metal.

19. The method as in claim 12, wherein in step (e), the cathode electron emitting sources are made by mesh printing, lithography or electrophoresis.

20. The method as in claim 12, wherein the panel is made of glass material.

21. The method as in claim 12, wherein in step (f) the panel is sealed with the anode substrate by vacuum process.
